(19) United States
(12) Patent Application Publication
(10) Pub. No.: US 2019/0047244 A1
(43) Pub. Date: Feb. 14, 2019

(54) THERMAL INSULATION STRUCTURE

(71) Applicant: I-DER-VON ENTERPRISE CO., LTD., New Taipei City (TW)

(72) Inventor: Hung-Hsu Huang, New Taipei City (TW)

(21) Appl. No.: 16/045,762

(22) Filed: Jul. 26, 2018

(30) Foreign Application Priority Data
Aug. 10, 2017 (TW) 106211819

(51) Int. Cl. B32B 1/08; B32B 15/14; F16L 59/14

(52) U.S. Cl. CPC B32B 1/08; B32B 15/14; B32B 2597/00; B32B 2307/304; F16L 59/14

(57) ABSTRACT

A thermal insulation structure, including: at least one first protection layer; at least one covering element, configured on the first protection layer; at least one thermal insulation element, configured inside the covering element; and at least one second protection layer, away from the first protection layer and configured on the covering element. Whereby, users can install the structure on a device to be thermally insulated and use the thermal insulation element to achieve a thermal insulation effect; the covering element is used to cover the thermal insulation element, and the first protection layer and second protection layer can prevent the covering element from being worn, allowing the present invention to achieve thermal insulation and wear-resistance effects.

### (A) TECHNICAL FIELD OF THE INVENTION

The present invention relates to a thermal insulation structure, and more particularly to a durable and not-easily-damaged thermal insulation structure, capable of achieving a thermal insulation effect through a thermal insulation element.

### (B) DESCRIPTION OF THE PRIOR ART

In many factories of metal forging and processing, metal must be heated to a liquid state, and can then be processed by means of molding. However, there are many high-temperature machines or pipelines in these factories. If someone inadvertently touches them, serious burns might occur. Therefore, an insulation jacket, which is a kind of thermal insulation equipment, will be installed on a high-temperature machine or pipeline; thermal insulation filling will be used for a general thermal insulation. However, if thermal insulation filling is scattered in the air and inhaled by a human body, it will cause lung disease. Therefore, heat-resistant cloth will be used to cover the thermal insulation filling when the thermal insulation filling is used. The thermal insulation equipment covering the thermal insulation filling with the heat-resistant cloth is so called and “insulation jacket”. Users may install the insulation jacket on a machine or pipeline to bring the thermal insulation effect into full play, thereby protecting persons from being scalded.

However, the heat-resistant cloth of an insulation jacket might be damaged after a long-term use, causing the thermal insulation filling covered in the heat-resistant cloth to be scattered in the air, and lung disease will be caused after inhaled by persons. In addition, the thermal insulation effect of the insulation jacket might be reduced due to the loss of the thermal insulation filling.

### SUMMARY OF THE INVENTION

To overcome the defects mentioned above, the present invention is proposed.

The main object of the present invention is to provide a thermal insulation structure, achieving a thermal insulation effect to prevent users from being scalded through the design of a thermal insulation element.

Another object of the present invention is to provide a thermal insulation structure, capable of covering the thermal insulation element to allow the thermal insulation element to maintain a complete thermal insulation effect through the design of a covering element.

Still another object of the present invention is to provide a thermal insulation structure, capable of protecting the covering element from being easily broken or damaged through the designs of first and second protection layers.

To achieve the objects mentioned above, the present invention proposes a thermal insulation structure, including: at least one first protection layer; at least one covering element, configured on the first protection layer; at least one thermal insulation element, configured inside the covering element; and at least one second protection layer, away from the first protection layer and configured on the covering element. Whereby, when users need to install thermal insulation equipment on a device to be thermally insulated such as a high-temperature machine or pipeline, they may install the thermal insulation structure of the present invention on the device to be thermally insulated and utilize the thermal insulation characteristics of the thermal insulation element to obtain the thermal insulation effect. Furthermore, the covering element covers the thermal insulation element completely, and the first protection layer is in contact with the device to be thermally insulated, capable of prevent the device to be thermally insulated and covering element from being broken or damaged due to the friction between them. In addition, the second protection layer can prevent users from destroying the covering element carelessly and allowing the present invention to achieve thermally insulative and durable effects.

### BRIEF DESCRIPTION OF THE DRAWINGS

FIG. 1 is a perspective view of a preferred embodiment according to the present invention;

FIG. 2 is a cross-sectional view of FIG. 1 taken along line A-A;

FIG. 3 is a perspective view of the embodiment of the present invention, showing internal components with dotted lines; and

FIG. 4 is a perspective view of the embodiment of the present invention upon implementation.

### DETAILED DESCRIPTION OF THE PREFERRED EMBODIMENTS

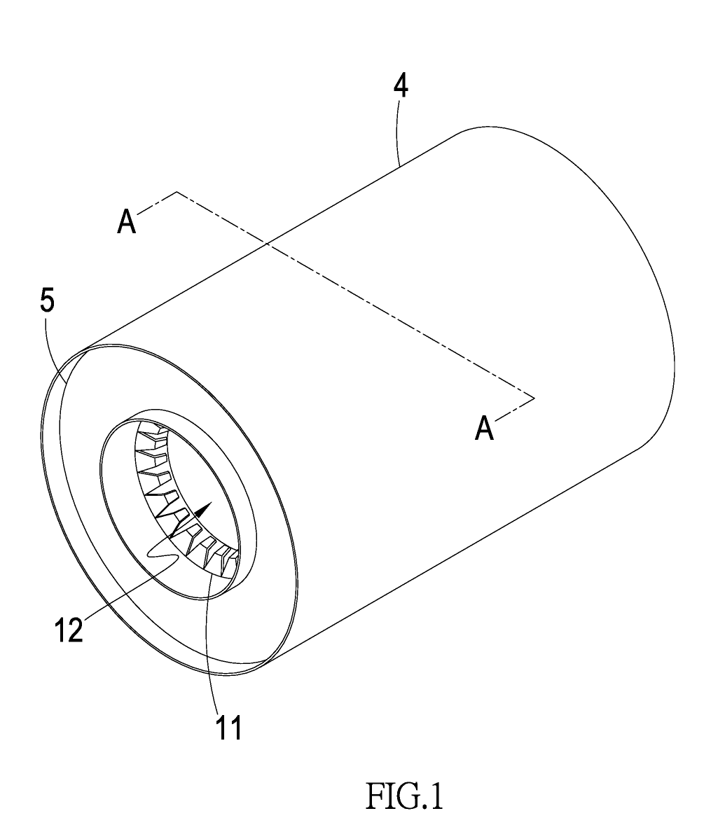

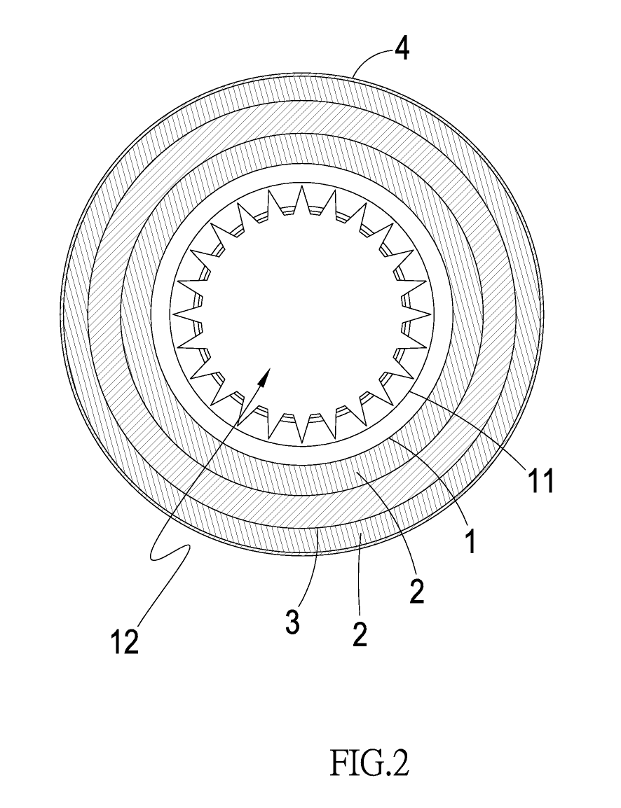

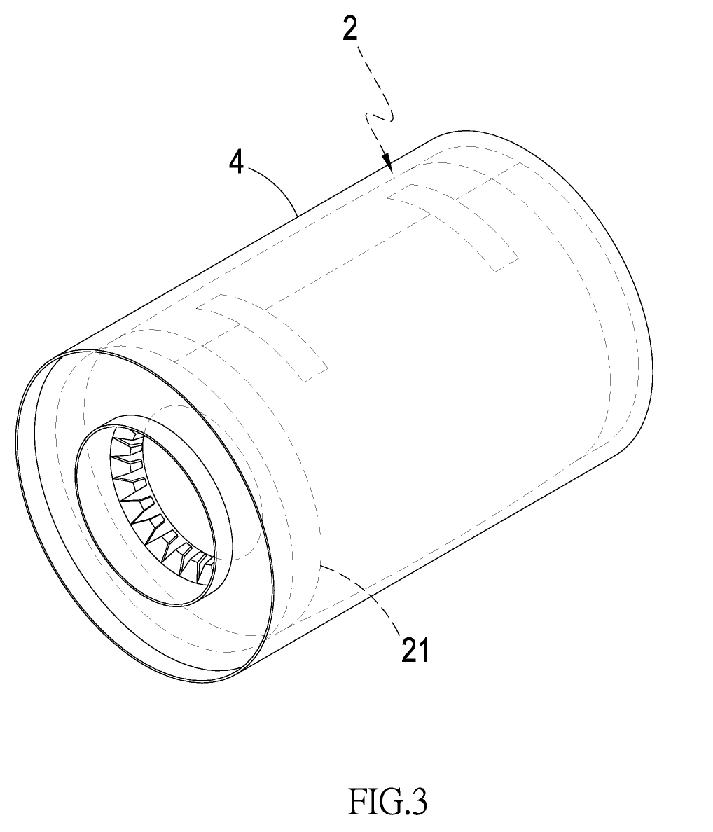

Referring to FIGS. 1 to 3, a thermal insulation structure of the present invention, in a preferred embodiment, includes at least one first protection layer 1, at least one covering element 2 and at least one protection layer 4.

One side of the first protection layer 1 is configured with at least one stopper 11, and the first protection layer 1 is wound to form an accommodation space 12, allowing at least one device to be thermally insulated to be accommodated therein, where the device to be thermally insulated is a pipeline or machine.

The covering element 2 is configured on the first protection layer 1 and made of cloth; at least one thermal insulation element 3 is configured inside the covering element 2 and made of thermal insulation filling, where the covering element 2 is configured with at least one seal element 21 adapted to seal the thermal insulation element inside the covering element 2.

The second protection layer 4 away from the first protection layer 1 is configured on the covering element 2, a connecting element 5 adapted to connect the first protection layer 1 with the second protection layer 4 is configured between the first protection layer 1 and second protection layer 4, and the first protection layer and second protection layer 4 are made of metal.

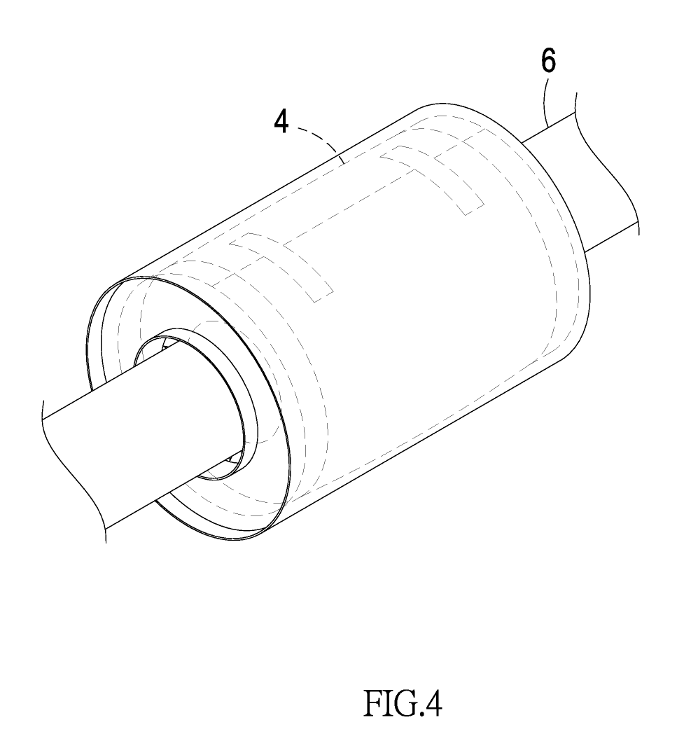

Referring to FIGS. 1 to 4, the thermal insulation structure of the present invention may be installed on a device 6 to be thermally insulated in order to prevent users from being scalded carelessly upon operation because the device 6 to be thermally insulated is a high-temperature pipeline or machine. The thermal insulation element 3 is porous thermal insulation filling, and the pores of the thermal insulation filling have air therein; air can isolate heat conduction since the thermal conductivity thereof is very low so that the thermal insulation effect can be achieved through the thermal insulation element 3. Furthermore, the thermal insulation element 2 is covered by the covering element 2, preventing the thermal insulation element 3 from being scattered in the air to be inhaled by users to cause lung damage, and allowing the thermal 3 to keep a complete thermal insulation effect. Furthermore, the seal element 21 is high temperature resistance thread; the thermal insulation element 3 can be sealed in the covering element 2 by sewing the seal element 21 on the covering element 2. In addition, since the first protection layer 1 is wound to form the accommodation space 12, users can place the device 6 to be thermally insulated inside the accommodation space 12, and the barbed stopper 11 is used to retain the device 6 to be thermally insulated on the thermal insulation structure of the present invention. Since the first protection layer 1 is positioned between the device 6 to be thermally insulated and covering element 2, preventing the device 6 to be thermally insulated and covering element 2 from being broken or damaged due to friction.

Furthermore, the second protection layer 4 can protect the covering element 2 from being broken or damaged due to users' carelessness upon the operation or maintenance of the device 6 to be thermally insulated, and the connecting element 5 being used to connect the first protection layer 1 with the second protection layer 4 makes sure that the covering element 2 is fixed between the first protection layer 1 and second protection layer 4.

From the description mentioned above, the present invention has the following advantages compared to the prior art:
1. The design of the thermal insulation element 3 can achieve the thermal insulation effect so as to prevent users from being scalded.
2. The design of the covering element 2 allows the full coverage of the element 3 to maintain the element 3 a complete thermal insulation effect.
3. The designs of the first protection layer 1 and second protection layer 4 can protect the covering element 2 from being broken or damaged easily.

I claim:

1. A thermal insulation structure, comprising:
at least one first protection layer;
at least one covering element, configured on said first protection layer;
at least one thermal insulation element, configured inside said covering element; and
at least one second protection layer, away from said first protection layer and configured on said covering element.

2. The structure according to claim 1, wherein at least one connecting element is configured between said first protection layer and second protection layer, and said connecting element is adapted to connect said first protection layer with said second protection layer.

3. The structure according to claim 1, wherein one side of said first protection layer is configured with at least one stopper.

4. The structure according to claim 1, wherein at least one seal element adapted to seal said thermal insulation element inside said covering element is configured on said covering element.

5. The structure according to claim 1, wherein said first protection layer is wound to form an accommodation space adapted to accommodate at least one device to be thermally insulated.

6. The structure according to claim 5, wherein said device to be thermally insulated is a pipeline or machine.

7. The structure according to claim 1, wherein said covering element is made of cloth.

8. The structure according to claim 1, wherein said thermal insulation element is thermal insulation filling.

9. The structure according to claim 1, wherein said first protection layer and second protection layer are made of metal material.
